(19) United States
(12) Patent Application Publication
(10) Pub. No.: US 2025/0077838 A1
(43) Pub. Date: Mar. 6, 2025

(54) SYSTEM AND METHOD FOR DYNAMICALLY ADJUSTING NEURAL NETWORK EFFICIENCY OF DYNAMIC NEURAL NETWORK RUNNING ON DEVICE

(71) Applicant: MEDIATEK INC., Hsin-chu (TW)

(72) Inventors: Chia-Hsiang Liu, Hsinchu City (TW); Cheng-Sheng Chan, Hsinchu City (TW); Min-Fong Horng, Hsinchu City (TW); Jui-Yang Hsu, Hsinchu City (TW); Sheng-Je Hung, Hsinchu City (TW); Hung-Jen Chen, Hsinchu City (TW)

(73) Assignee: MEDIATEK INC., Hsin-Chu (TW)

(21) Appl. No.: 18/239,753

(22) Filed: Aug. 29, 2023

(51) Int. Cl. G06N 3/045

(52) U.S. Cl. CPC G06N 3/045

(57) ABSTRACT

A system for dynamically adjusting neural network efficiency of a dynamic neural network running on a device includes a detector and a signal generator. The detector is arranged to detect a change of a status of the device, to generate a trigger signal. The signal generator is arranged to generate a control signal according to the trigger signal, to dynamically adjust the neural network efficiency of the dynamic neural network.

### BACKGROUND

The present invention is related to neural network, and more particularly, to a system for dynamically adjusting neural network efficiency of a dynamic neural network running on a device and an associated method.

For neural network architecture design, using a neural architecture search (NAS) method is gradually becoming a trend. For example, a searched result of the NAS method (e.g. a dynamic neural network including multiple switchable sub-networks) can be deployed on an edge device (e.g. a mobile phone). In a certain scenario, artificial intelligence (AI) technology can be used to perform real-time video noise reduction on the edge device. The edge device, however, may be prone to overheating, so some processes need to be performed for controlling a status (e.g. temperature) of the edge device. For example, for a conventional method, Quality of Service (QoS) may be utilized to control the status (e.g. control from high temperature to low temperature) through adjusting hardware setting of the edge device (e.g. reducing the voltage or the frame rate), which may limit the design flexibility and cause inconvenience to a user. As a result, a novel system and an associated method that can dynamically adjust neural network efficiency in response to different status of a device at runtime are urgently needed.

### SUMMARY

It is therefore one of the objectives of the present invention to provide a system for dynamically adjusting neural network efficiency of a dynamic neural network running on a device and an associated method, to address the above-mentioned issues.

According to an embodiment of the present invention, a system for dynamically adjusting neural network efficiency of a dynamic neural network running on a device is provided. The system comprises a detector and a signal generator. The detector is arranged to detect a change of a status of the device, to generate a trigger signal. The signal generator is arranged to generate a control signal according to the trigger signal, to dynamically adjust the neural network efficiency of the dynamic neural network.

According to an embodiment of the present invention, a method for dynamically adjusting neural network efficiency of a dynamic neural network running on a device. The method comprises: detecting a change of a status of the device, to generate a trigger signal; and generating a control signal according to the trigger signal, to dynamically adjust the neural network efficiency of the dynamic neural network.

One of the benefits of the present invention is that, by the QoS system and the method of the present invention, the neural network efficiency of the dynamic neural network running on the edge device can be dynamically adjusted according to the status (e.g. the temperature) of the edge device. Compared with a case where the Qos is utilized to control the status through adjusting hardware setting of the edge device, the QoS system and the method of the present invention can increase the design flexibility and bring convenience to a user.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device according to an embodiment of the present invention.

FIG. 2 is a diagram illustrating a dynamic neural network running on an edge device according to an embodiment of the present invention.

FIG. 3 is a diagram illustrating a configuration between a Quality of Service (QoS) system, an edge device, and a dynamic neural network according to an embodiment of the present invention.

FIG. 4 is a flow chart of a method for dynamically adjusting neural network efficiency of a dynamic neural network running on a device according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . .”.

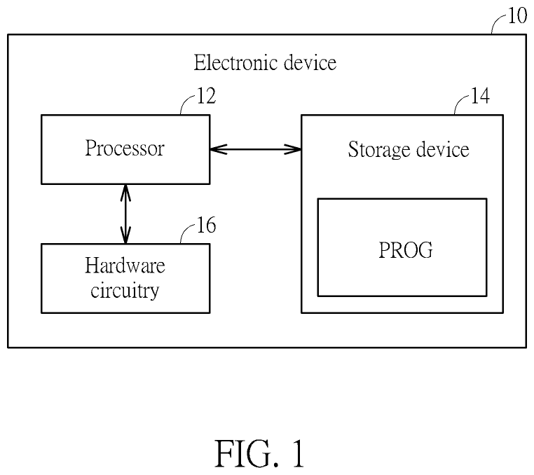

FIG. 1 is a diagram illustrating an electronic device 10 according to an embodiment of the present invention. By way of example, but not limitation, the electronic device 10 may be a portable device such as a smartphone or a tablet. The electronic device 10 may include a processor 12, a storage device 14, and a hardware circuitry 16. The processor 12 may be a single-core processor or a multi-core processor. The storage device 14 is a computer-readable medium, and is arranged to store computer program code PROG. The processor 12 is equipped with software execution capability. The computer program code PROG may include a neural network optimization algorithm (e.g. a neural architecture search (NAS) algorithm). The electronic device 10 may be regarded as a computer system using a computer program product that includes a computer-readable medium containing the computer program code. The hardware circuitry 16 is pure hardware that may consist of logic gates only, and performs designated functions without software execution. Regarding a Quality of Service (Qos) system as proposed by the present invention, it may be embodied on the electronic device 10. For example, the QoS system may include software-based functions implemented by computer program code PROG running on the processor 12 and/or hardware-based functions implemented by the hardware circuitry 16.

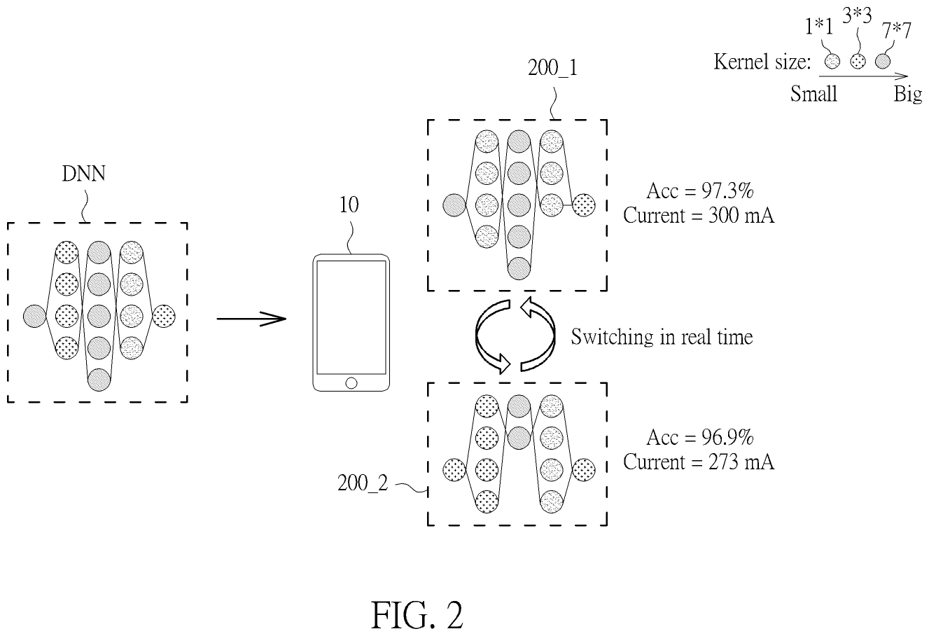

FIG. 2 is a diagram illustrating a dynamic neural network DNN running on an edge device (e.g. the electronic device 10 shown in FIG. 1) according to an embodiment of the present invention, wherein the electronic device 10 is a smartphone. When the NAS algorithm is loaded and executed by the processor 12, the NAS algorithm instructs the processor 12 to generate the dynamic neural network DNN, but the present invention is not limited thereto. The dynamic neural network DNN may be generated by other algorithms or other means. The dynamic neural network DNN is a model with multiple switchable sub-networks, and neural network efficiency of the dynamic neural network DNN can be dynamically adjusted by switching model architecture of the dynamic neural network DNN between the sub-networks, without reloading or retraining. For example, under a condition that network efficiency of a first sub-network is higher than that of a second sub-network, the quality and the power consumption of the first sub-network will be higher than that of the second sub-network, and vice versa.

The dynamic neural network DNN may include multiple switchable sub-networks 200_1-200_N, wherein Nis an integer greater than 1 (i.e. N>1). Each of the sub-networks 200_1-200_N may have 5 convolution layers, and the convolution layers may have different kernel sizes and different numbers of channels. For example, a kernel size of each convolution layer in each of the sub-networks 200_1-200_N may be 1*1, 3*3, or 7*7. For brevity and simplicity, the dynamic neural network DNN is shown having only 2 sub-networks 200_1 and 200_2 (i.e. N=2). The kernel size of the convolutional layers from left to right of the sub-network 200_1 is 7*7, 1*1, 7*7, 1*, and 3*3, respectively, and the kernel size of the convolutional layers from left to right of the sub-network 200_2 is 3*3, 3*3, 7*7, 1*1, and 3*3, respectively. The number of channels of the convolutional layers from left to right of the sub-network 200_1 is 1, 4, 5, 3, and 1, respectively, and the number of channels of the convolutional layers from left to right of the sub-network 200_2 is 1, 4, 2, 4, and 1, respectively. The sub-network 200_1 has accuracy of 97.3% and power consumption of 300 mA (for brevity, labeled as “Acc=97.3%” and “Current=300 mA”, respectively, in FIG. 2), and the sub-network 200_2 has accuracy of 96.9% and power consumption of 273 mA (for brevity, labeled as “Acc=96.9%” and “Current =273 mA”, respectively, in FIG. 2). It should be noted that the higher the accuracy of a sub-network is, the higher the neural network efficiency of the sub-network is. That is, the sub-network 200_1 has higher neural network efficiency but consumes more power, and the sub-network 200_2 has lower neural network efficiency but saves power. When there is a need, the model architecture of the dynamic neural network DNN can be switched between the sub-networks 200_1 and 200_2 in real-time.

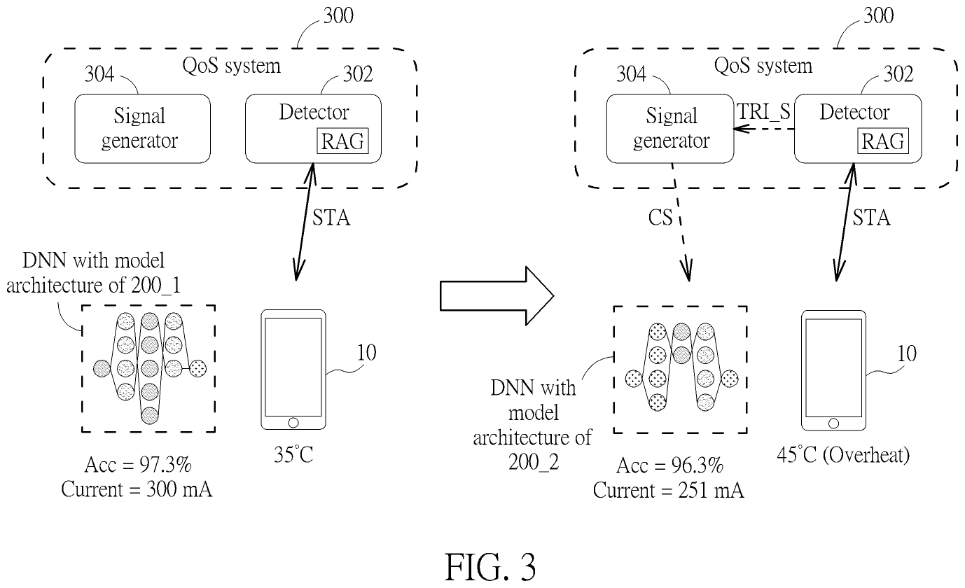

FIG. 3 is a diagram illustrating a configuration between a Qos system 300, an edge device (e.g. electronic device 10 shown in FIG. 1), and the dynamic neural network DNN according to an embodiment of the present invention, wherein the QoS system 300 may be a hardware component executed on the processor 12. The QoS system 300 may be arranged to dynamically control the neural network efficiency of the dynamic neural network DNN according to a status STA of the electronic device 10. As shown in FIG. 3, the QoS system 300 may include a detector 302 and a signal generator 304. The detector 302 may be arranged to keep detecting a change of the status STA, and determine whether the change of the status STA is out of a range RAG. In response to the change of the status STA being out of the range RAG, the detector 302 may generate a trigger signal TRI_S to the signal generator 304 for subsequent processing. In this embodiment, the status STA may be temperature of the electronic device 10, and the range RAG may be ±3° C., however, the present invention is not limited thereto. In some embodiments, the status STA may be an usage rate of the processor 12 in the electronic device 10, and the range RAG may be ±20% of the usage rate. In some embodiments, the status STA may be a power consumption of the electronic device 10, and the range RAG can be ±10% of the power consumption. These alternative designs all fall within the scope of the present invention.

In this embodiment, it is assumed that a current temperature of the electronic device 10 is 35° C., current model architecture of the dynamic neural network DNN is the sub-network 200_1, and an application (APP) where the dynamic neural network DNN involved (e.g. an APP for real-time face recognition or an APP for real-time video noise reduction) runs on the electronic device 10. After a few minutes, the temperature of the electronic device 10 is increased from 35° C. to 45° C. In response to the change of the status STA (45° C.-35° C.=10° C.) being out of the range RAG (e.g. ±3° C.), the detector 302 may generate the trigger signal TRI_S to the signal generator 304 for triggering the signal generator 304 to perform subsequent processing. After receiving the trigger signal TRI_S, the signal generator 304 may be arranged to generate a control signal CS to dynamically adjust the neural network efficiency of the dynamic neural network DNN. For example, channel size, kernel size, and/or bit width of the dynamic neural network DNN can be adjusted to dynamically adjust the neural network efficiency. Specifically, the signal generator 304 may switch the model architecture of the dynamic neural network DNN between multiple sub-networks (e.g. the sub-networks 200_1 and 200_2) according to the control signal CS. In order to prevent the electronic device 10 from overheating, a lightweight sub-network with lower power consumption may be selected to be the model architecture of the dynamic neural network DNN. As a result, the model architecture of the dynamic neural network DNN is switched from the sub-network 200_1 with higher neural network quality and higher power consumption to the sub-network 200_2 with lower neural network quality and lower power consumption.

In some embodiments, it is assumed that the temperature of the electronic device 10 is decreased from a high temperature to a low temperature, the change of the temperature of the electronic device 10 is out of the range RAG (e.g. ±3° C.; i.e. the change of the temperature of the electronic device 10 is larger than 3° C.), and the current model architecture of the dynamic neural network DNN is the sub-network 200_2. In order to enhance the performance of the electronic device 10, a powerful sub-network with higher neural network efficiency may be selected to be the model architecture of the dynamic neural network DNN. As a result, the signal generator 304 may switch the model architecture of the dynamic neural network DNN from the sub-network 200_2 to a sub-network with higher neural network efficiency (e.g. the sub-network 200_1).

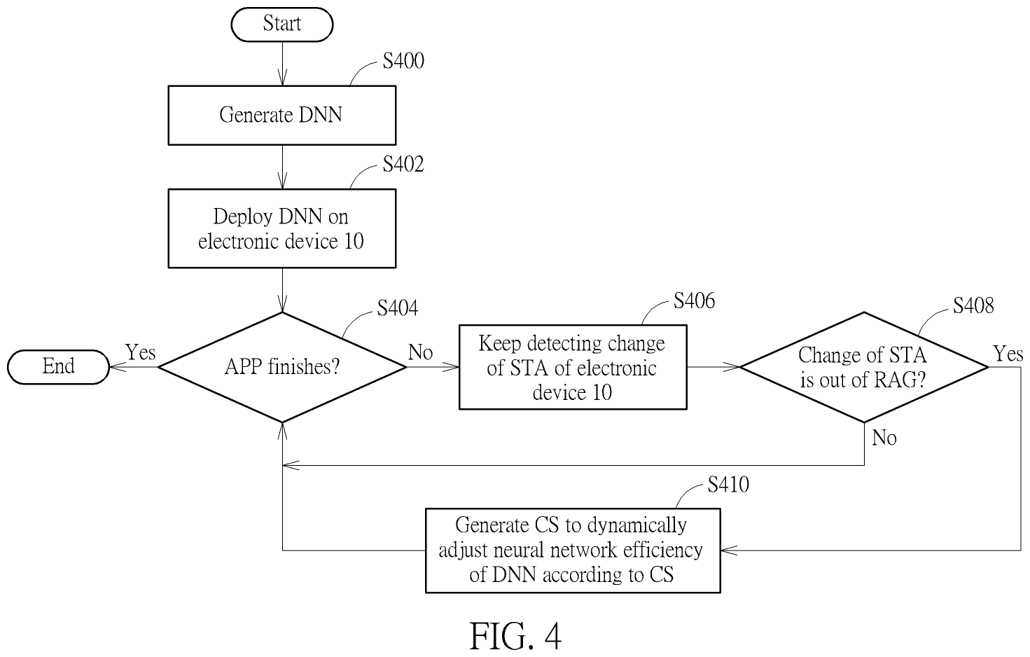

FIG. 4 is a flow chart of a method for dynamically adjusting neural network efficiency of a dynamic neural network running on a device (e.g. the dynamic neural network DNN running on the electronic device 10) according to an embodiment of the present invention. Provided that the result is substantially the same, the steps are not required to be executed in the exact order shown in FIG. 4. For example, the method shown in FIG. 4 may be employed by the processor 12 shown in FIG. 1 and the QoS system 300 shown in FIG. 3.

In Step S400, the dynamic neural network DNN is generated.

In Step S402, the dynamic neural network DNN is deployed on the electronic device 10, wherein an APP where the dynamic neural network DNN involved (e.g. an APP for real-time face recognition) runs on the electronic device 10.

In Step S404, it is determined that whether the APP finishes. If Yes, the flow ends; if No, Step S406 is entered.

In Step S406, a change of the status STA of the electronic device 10 is kept detected by the detector 302.

In Step S408, it is determined that whether the change of the status STA is out of the range RAG. If Yes, Step 410 is entered; if No, Step S404 is returned.

In Step S410, the trigger signal TRI_S is generated to the signal generator 304 by the detector 302, and the control signal CS is generated by triggering the signal generator 304 through the trigger signal TRI_S, to dynamically adjust the neural network efficiency of the dynamic neural network DNN according to the control signal CS.

Since a person skilled in the pertinent art can readily understand details of the steps after reading above paragraphs directed to the processor 12 shown in FIG. 1 and the QoS system 300 shown in FIG. 3, further descriptions are omitted here for brevity.

In summary, by the QoS system and the method of the present invention, the neural network efficiency of the dynamic neural network running on the edge device can be dynamically adjusted according to the status (e.g. the temperature) of the edge device. Compared with a case where the QoS is utilized to control the status through adjusting hardware setting of the edge device, the QoS system and the method of the present invention can increase the design flexibility and bring convenience to a user.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A system for dynamically adjusting neural network efficiency of a dynamic neural network running on a device, comprising:
a detector, arranged to detect a change of a status of the device, to generate a trigger signal; and
a signal generator, arranged to generate a control signal according to the trigger signal, to dynamically adjust the neural network efficiency of the dynamic neural network.

2. The system of claim 1, wherein the dynamic neural network comprises multiple sub-networks.

3. The system of claim 2, wherein the signal generator is further arranged to switch model architecture of dynamic neural network between the multiple sub-networks according to the control signal.

4. The system of claim 1, wherein the detector is further arranged to determine whether the change of the status of the device is out of a range, and in response to the change of the status of the device being out of the range, the detector generates the trigger signal.

5. The system of claim 1, wherein in response to a change of temperature of the device, the detector generates the trigger signal.

6. The system of claim 5, wherein the change of the temperature of the device indicates that the temperature of the device is changed from a first temperature to a second temperature, the second temperature is higher than the first temperature, and a difference between the first temperature and the second temperature is out of a range.

7. The system of claim 6, wherein the dynamic neural network comprises multiple sub-networks, the multiple sub-networks comprise a first sub-network and a second sub-network, the first sub-network is current model architecture of the dynamic neural network, and neural network efficiency of the first sub-network is higher than neural network efficiency of the second sub-network; and in response to the difference between the first temperature and the second temperature being out of the range, the signal generator switches model architecture of the dynamic neural network from the first sub-network to the second sub-network according to the control signal.

8. The system of claim 5, wherein the change of the temperature of the device indicates that the temperature of the device is changed from a first temperature to a second temperature, the second temperature is lower than the first temperature, and a difference between the first temperature and the second temperature is out of a range.

9. The system of claim 8, wherein the multiple sub-networks comprise a first sub-network and a second sub-network, the first sub-network is current model architecture of the dynamic neural network, and neural network efficiency of the first sub-network is lower than neural network efficiency of the second sub-network;
and in response to the difference between the first temperature and the second temperature being out of the range, the signal generator switches model architecture of the dynamic neural network from the first sub-network to the second sub-network according to the control signal.

10. A method for dynamically adjusting neural network efficiency of a dynamic neural network running on a device, comprising:
detecting a change of a status of the device, to generate a trigger signal; and
generating a control signal according to the trigger signal, to dynamically adjust the neural network efficiency of the dynamic neural network.

11. The method of claim 10, wherein the dynamic neural network comprises multiple sub-networks.

12. The method of claim 11, wherein the method further comprises:
switching model architecture of dynamic neural network between the multiple sub-networks according to the control signal.

13. The method of claim 10, wherein the step of detecting the change of a status of the device, to generate the trigger signal further comprises:
determining whether the change of the status of the device is out of a range; and
in response to the change of the status of the device being out of the range, generating the trigger signal.

14. The method of claim 10, wherein the step of detecting the change of the status of the device, to generate the trigger signal comprises:
in response to a change of temperature of the device, generating the trigger signal.

15. The method of claim 14, wherein the change of the temperature of the device indicates that the temperature of the device is changed from a first temperature to a second temperature, the second temperature is higher than the first temperature, and a difference between the first temperature and the second temperature is out of a range.

16. The method of claim 15, wherein the dynamic neural network comprises multiple sub-networks, the multiple sub-networks comprise a first sub-network and a second sub-network, the first sub-network is current model architecture of the dynamic neural network, and neural network efficiency of the first sub-network is higher than neural network efficiency of the second sub-network; and the method further comprises:
in response to the difference between the first temperature and the second temperature being out of the range, switching model architecture of the dynamic neural network from the first sub-network to the second sub-network according to the control signal.

17. The method of claim 14, wherein the change of the temperature of the device indicates that the temperature of the device is changed from a first temperature to a second temperature, the second temperature is lower than the first temperature, and a difference between the first temperature and the second temperature is out of a range.

18. The method of claim 17, wherein the dynamic neural network comprises multiple sub-networks, the multiple sub-networks comprise a first sub-network and a second sub-network, the first sub-network is current model architecture of the dynamic neural network, and neural network efficiency of the first sub-network is lower than neural network efficiency of the second sub-network; and the method further comprises:
in response to the difference between the first temperature and the second temperature being out of the range, switching model architecture of the dynamic neural network from the first sub-network to the second sub-network according to the control signal.
